(19) United States
(12) Patent Application Publication
(10) Pub. No.: US 2010/0002883 A1
(43) Pub. Date: Jan. 7, 2010

(54) SECURITY PROCEDURE AND APPARATUS FOR HANDOVER IN A 3GPP LONG TERM EVOLUTION SYSTEM

(75) Inventors: Mohammed Sammour, Montreal (CA); Rajat P. Mukherjee, Stanford, CA (US); Shankar Somasundarm, Deer Park, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS INC., Wilmington, DE (US)

(21) Appl. No.: 12/181,424

(22) Filed: Jul. 29, 2008

Related U.S. Application Data
(60) Provisional application No. 60/953,779, filed on Aug. 3, 2007.

(51) Int. Cl. H04L 9/00; H04K 1/00

(52) U.S. Cl. 380/272; 380/270; 380/277; 380/273; 380/44

(57) ABSTRACT

A method and apparatus for implementing a security procedure during handover of a wireless transmit/receive unit (WTRU) in wireless communications that controls the behavior of a handover target if it cannot support the required security algorithms. The handover source can detect that the target does not support the required security algorithms and the WTRU can detect that security algorithms may change during handover. Security procedures for the WTRU include contingencies for Radio Link Failure and if the public land mobile network (PLMN) changes.

### CROSS REFERENCE TO RELATED APPLICATIONS

This application claims the benefit of U.S. provisional application 60/953,779, filed on Aug. 3, 2007, which is incorporated by reference as if fully set forth.

### TECHNOLOGY FIELD

The present invention relates to wireless communications, in particular to security in mobile user equipment in Third Generation Partnership Project (3GPP) long term evolution (LTE) systems.

### BACKGROUND

The Third Generation Partnership Project (3GPP) Long Term Evolution (LTE) program goal is to bring new technology, architecture and methods in the new LTE settings and configurations. The result will be improved spectral efficiency, reduced latency, improved utilization of radio resources to achieve faster user experiences, and richer applications and services with reduced cost.

As part of this evolution process, the 3GPP group will use different security architecture in LTE than used in Universal Mobile Telecommunication System (UMTS) and Global System for Mobile communication (GSM) systems. For comparative purposes, the UMTS Authentication and Key Agreement (AKA) procedures, in packet switched (PS) domain, are considered here to be the baseline for the proposed new LTE procedures. A discussion of the existing UMTS AKA procedures follows along with a brief description of the proposed LTE security architecture.

The UMTS AKA and ciphering procedures are spread over multiple protocol layers and use both Non-Access Stratum (NAS) and radio resource control (RRC) signaling to provide a secure communication environment. In brief, identification of the wireless transmit/receive unit (WTRU) along with authentication is accomplished via NAS signaling. Once authentication at the NAS level is accomplished, ciphering and/or integrity protection is activated by the network using the Security Mode Command, which is a RRC message. Once security is activated using the Security Mode Command the NAS layer in the WTRU first passes the ciphering and integrity keys (CK and IK) to the Access Stratum (AS). The RRC on receiving these keys passes them on to the radio link control (RLC) and media access control (MAC). The actual ciphering and integrity protection is typically performed in the RLC, but is performed in the MAC in case of transparent RLC mode traffic. Once security has been activated, all control plane (C-plane) and user data plane (U-plane) security is performed in the RLC or MAC.

For LTE, a radically different architecture for security has been proposed. The main difference is that instead of a single security layer, i.e. in the MAC/RLC, there are proposed three layers of security—NAS security, RRC security and U-plane security. Each layer has its own keys. NAS security terminates in the Mobility Management Entity (MME), i.e. the core network, and is performed in the NAS layer. RRC security terminates in the evolved Node B (e-NB) and is performed in the Packet Data Convergence Protocol (PDCP). The U-plane security consists of ciphering only, i.e. no integrity protection, and is also performed in the PDCP. In brief, the AKA procedures are completed in the NAS, and NAS security keys are derived first. The RRC/U-plane security parameters are derived in a cryptographically separate manner from the NAS keys, i.e. knowledge of RRC/U-plane keys does not allow an attacker to determine the NAS keys. The main rationale for this separation was that in LTE, one might have e-NBs in vulnerable locations, e.g. home Node Bs, and since RRC, and therefore security, is terminated in the e-NB, this was considered to be a security risk. Hence two levels of security were decided.

A diagrammatic representation of the LTE key hierarchy is shown in FIG. 1, comprising:
K 110 is the permanent key stored on the UMTS Subscriber Identity Module (USIM) and in the Authentication Center AuC 105.
CK, IK 115, 120 are the pair of keys derived in the AuC and on USIM during a NAS AKA run. Usually this was provided directly to the RLC and/or MAC.
K_{ASME} 125 is a key derived by the WTRU and in Home Subscriber Server (HSS) from CK, IK 115, 120 during an AKA run. K_{ASME} 125 shall depend on the public land mobile network (PLMN) identity.
K_{eNB} 130 is a key derived by the WTRU and Multimedia Message Entity (MME) from K_{ASME} 125. K_{eNB} 130 may only be used for the derivation of keys for RRC traffic and the derivation of keys for UP traffic. UP traffic is the term used for data such as the web pages one surfs and the phone calls one makes.
K_{eNB} 130 shall depend on the identity of the eNB requesting it from the MME.
K_{NASint} 135 is a key derived by the WTRU and MME from K_{ASME} 125. It may only be used for the protection of NAS traffic with a particular integrity algorithm. It may depend on MME identity.
K_{NASenc} 136 is a key derived by the WTRU and MME from K_{ASME} 125. It may only be used for the protection of NAS traffic with a particular encryption algorithm. It may depend on MME identity.
K_{UPenc} 145 is a key, which may only be used for the protection of UP traffic with a particular encryption algorithm. This key is derived by the WTRU and eNB 147 from K_{eNB} 130, as well as an identifier for the encryption algorithm.
K_{RRcint} 150 is a key, which may only be used for the protection of RRC traffic with a particular integrity algorithm. K_{eNB-RRCint} 150 is derived by the WTRU and eNB 147 from K_{eNB}, as well as an identifier for the integrity algorithm.
K_{RRCenc} 155 is a key, which may only be used for the protection of RRC traffic with a particular encryption algorithm. K_{RRCenc} is derived by the WTRU and eNB 147 from K_{eNB} 130.
   The K_{RRcint} and K_{RRCenc} are collectively referred to as RRC keys while the K_{UPenc} key is referred to as the U-plane key. The K_{NASenc} and K_{NASint} are collectively referred to as the NAS keys. The RRC and U-plane keys may be derived with the cell radio network temporary identifier (C-RNTI) as an input.

During handover without MME involvement (intra-MME handover) the source eNB will transfer WTRU-context to the target eNB. This context shall include the WTRU algorithm capabilities, allowed RRC/UP algorithms for the WTRU, and the currently used security algorithms in the source eNB.

The target eNB selects the RRC and UP algorithms for use (after handover) and transfers it to the source eNB. If the currently used algorithms are supported by the target eNB the choice shall be the currently used security algorithms. In other cases target eNB selects an algorithm based on the WTRU capabilities and allowed algorithms set for the WTRU and includes the selected algorithms in the integrity protected and ciphered Handover Command message to the WTRU. The source eNB may check that the target eNB algorithm selection complies with the allowed algorithms for the WTRU.

The 3GPP Working Group on security (SA3) is concerned about the role of a compromised e-NB during the handover procedure: either the source e-NB or the target e-NB may “downgrade” the algorithms during handover to be used later for ciphering and integrity protection, thereby forcing the WTRU to a weaker security “state”. What was not defined was how would the source/target behave if the target did not support the algorithms.

It would therefore be desirable to implement a solution where the source eNB may check that the target eNB algorithm selection complies with the allowed algorithms for the WTRU. Further the WTRU may compare the algorithms selected by the target and communicated to it by the source with those received in a NAS Security Mode Command outlining acceptable algorithms. If either the source or the target is compromised and tries to downgrade the algorithms, the WTRU may still be able to take corrective action.

It is unclear as to what the WTRU or the source e-NB would do if either detected that the security algorithms were being downgraded. Therefore, it would be desirable to offer some possible courses of action for the WTRU and for the source e-NB. In addition, a method and apparatus to close other possible security loopholes and provide some key management features for handling mobility would be desirable.

### SUMMARY

A method and apparatus relate to selection and verification of security algorithms, for ciphering and/or integrity protection, upon handover. The method and apparatus also relate to the behavior of a target if it cannot support the required security algorithms, the behavior of the source if it detects that the target does not support the required security algorithms, the behavior of the WTRU if it detects that security algorithms may change during handover, the WTRU security procedures during Radio Link Failure during handover, the WTRU security procedures if the public land mobile network (PLMN) in which it is operating changes, and the WTRU architecture for implementing NAS signaling.

### BRIEF DESCRIPTION OF THE DRAWINGS

A more detailed understanding may be had from the following description, given by way of example and to be understood in conjunction with the accompanying drawings wherein:

FIG. 1 is a block diagram of the key hierarchy in LTE;

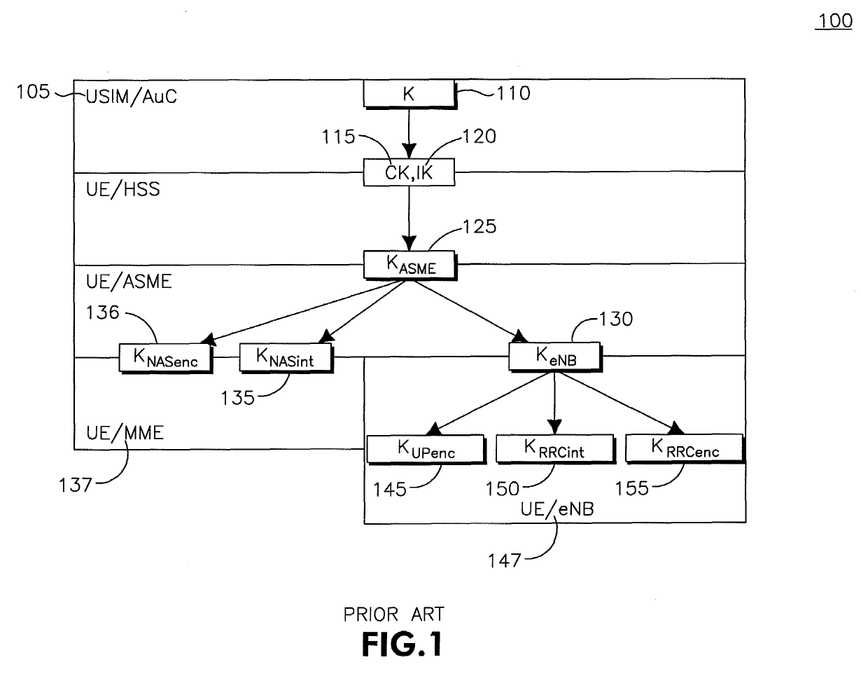

FIG. 2 is a block diagram of a procedure in a target upon receiving a handover request;

FIG. 3 is a block diagram of a procedure when an improper algorithm selection is made;

FIG. 4 is a block diagram of a procedure when a source queries multiple targets during handover preparation;

FIGS. 5A and 5B are block diagrams of a procedure when a compromised source may “downgrade” security by modifying the algorithm selection;

FIG. 6 is a block diagram of a procedure where the source e-NB selects a different algorithm than the one selected by the target e-NB;

FIG. 7 is a block diagram of the effect on the WTRU when the handover procedure fails;

FIG. 8 is a block diagram of a procedure related to security when a change in PLMN occurs in Idle Mode or Active Mode; and

FIG. 9 is a block diagram of a wireless communication system configured for secured handover in LTE.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, an enhanced Node-B (e-NB), a site controller, an access point (AP), or any other type of interfacing device capable of operating in a wireless environment.

Herein, unless otherwise indicated, the phrase “security keys” refers to ciphering and/or integrity protection keys of RRC and/or U-plane traffic as necessary. Handover may refer to Intra-MME, Inter-MME, and Inter-Radio Access Technology (Inter-RAT), where RAT includes other 3GPP as well as non-3GPP RAT. The method and apparatus include signaling that may be extended to other radio technologies, for example Wideband Code Division Multiple Access (WCDMA).

Existing handover procedures dictate that the target perform admission control and make the handover decision based on radio related criteria, for example resources available. It has been proposed that if the target is presented with a list of suitable algorithms, for example by the source, for security ciphering and/or integrity protection, the target will select an algorithm from the list of suitable algorithms.

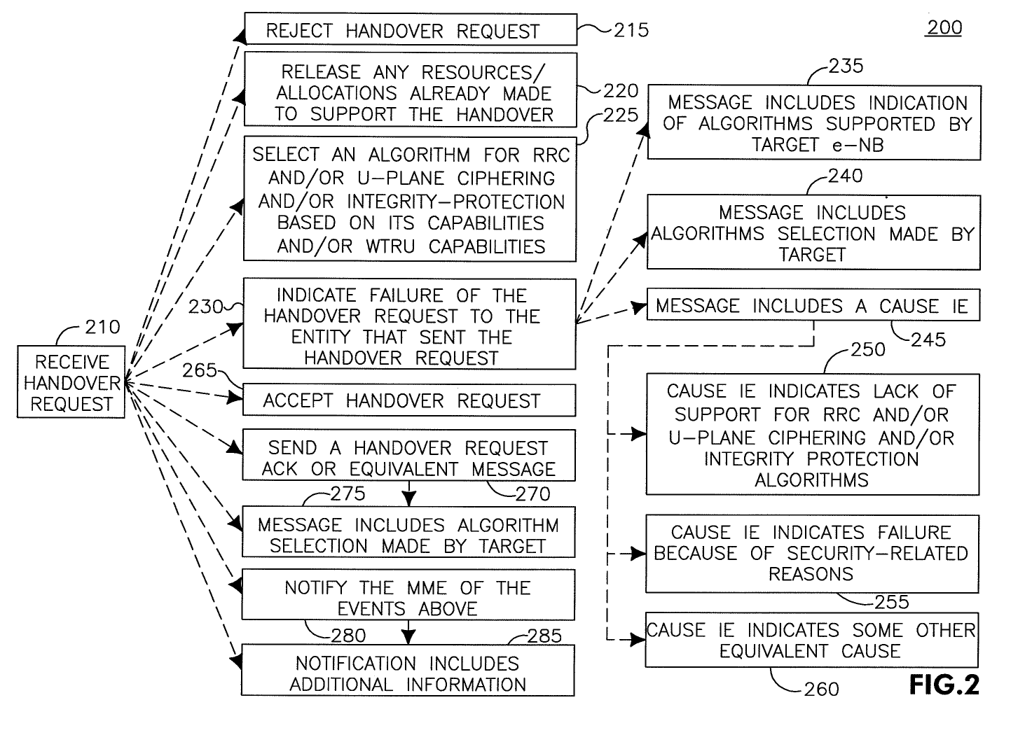

It is possible, however, that the target may not support the security algorithm in the list of suitable algorithms. It is also possible that the target may or may not support the algorithms in the WTRU. FIG. 2 is a block diagram 200 illustrating the actions in the target upon receiving a handover request 210, and are described as follows, where these actions may be undertaken in any order and/or combination: 1) the target may reject the handover request 215, 2) the target may release any resources/allocations already made to support the handover 220, 3) the target may still make an algorithm selection for RRC and/or U-plane ciphering and/or integrity-protection based on its capabilities and/or WTRU capabilities 225, 4) the target may indicate the failure of the handover request to the entity that sent the handover request 230. As an example in LTE systems, the target e-NB may indicate the failure of the handover request to the source e-NB in the HANDOVER PREPARATION FAILURE or equivalent message. The message may include an indication of the algorithms supported by the target e-NB 235. The message may include the algorithm selection made by the target 240. The message may include a Cause IE 245 indicating lack of support for RRC and/or U-plane ciphering and/or integrity protection algorithms 250, failure because of security-related reasons 255 where an exact cause may or may not be provided, or some other equivalent cause 260.

Continuing with FIG. 2, the actions that may be undertaken in the target in any order and/or combination also include: 5) the target may accept the handover request 265, 6) the target may send a HANDOVER REQUEST ACKNOWLEDGE or equivalent message 270. The message may include an indication of the algorithms supported by the target. The message may include the algorithm selection made by the target 275. 7) The target may notify the MME of the events above 280. The notification may include additional information described above 285, for example target algorithm selection/capabilities.

For LTE systems, the source may be the source e-NB or source MME and the target may be the target e-NB or the target MME. It is possible that an e-NB is aware of the algorithm capabilities at the source, i.e. the source e-NB keeps a record of the algorithm capabilities of its neighbors. This information may have been obtained from its neighbors or from the MME. This information may have been obtained periodically, triggered by some event, for example if the algorithm supported changes, or by continuously updating information received from the target regarding its capabilities from various handover messages. The source e-NB can use this algorithm capability information of its neighbors to make handover related decisions.

During handover preparation, the target may also indicate to the WTRU Key Set Identifier(s) identifying any combination of the keys, for example any combination of K_{ASME}, K_{eNB}, K_{RRCenc}, K_{RRcint}, K_{UPenc}, K_{NASenc}, K_{NASint}, and the algorithms selected. These KSI(s) may be passed to the WTRU, perhaps in a manner transparent to the source, using the Handover Command. These KSI(s) may identify the keys/algorithms derived/selected during HO Confirm, or in a subsequent connection request.

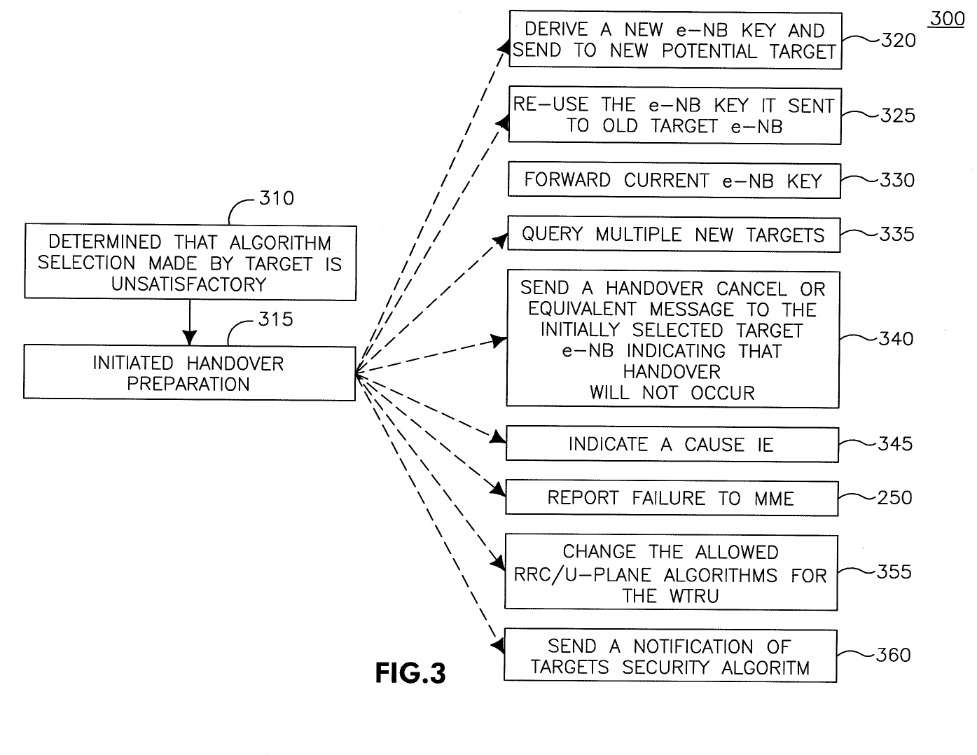

FIG. 3 is a block diagram illustrating actions taken when an improper algorithm selection is made 300. During handover preparation, the source e-NB may determine that the algorithm selection made by the target is not satisfactory 310, for example because it downgrades security or is incompatible with the WTRU capabilities, or that the target has rejected the handover for some reason. In one embodiment, the source may initiate handover preparation 315 with some other target, for example the next best cell as determined by the source, or perhaps the best cell not belonging to the rejected target e-NB. Specifically for LTE systems, the source e-NB may now derive a new e-NB key and send it to the new potential target e-NB 320 or it may re-use the e-NB key it sent to the old target e-NB 325, i.e. the one it just rejected, or it may forward its current e-NB key 330. It may choose to query multiple new targets 335, which will described in more detail below. It may choose to send a HANDOVER CANCEL or equivalent message to the initially selected target e-NB indicating that it should release the radio and/or any other resources it reserved and indicating that handover will not occur 340. It may choose to indicate a cause IE in this message for this reason 345. The Cause IE may indicate that the reason behind handover cancellation was that the security algorithm selection was incompatible with WTRU capabilities and/or that the algorithm selection downgraded the security of WTRUs or some equivalent cause. It may choose to report this failure to the MME 350. It may try and change the allowed RRC/U-plane algorithms for the WTRU 355. It may send a notification of targets' security algorithm capabilities to the MME 360. The specific procedure adopted may vary depending on the incompatible algorithm, for example RRC, U-plane ciphering and/or integrity protection.

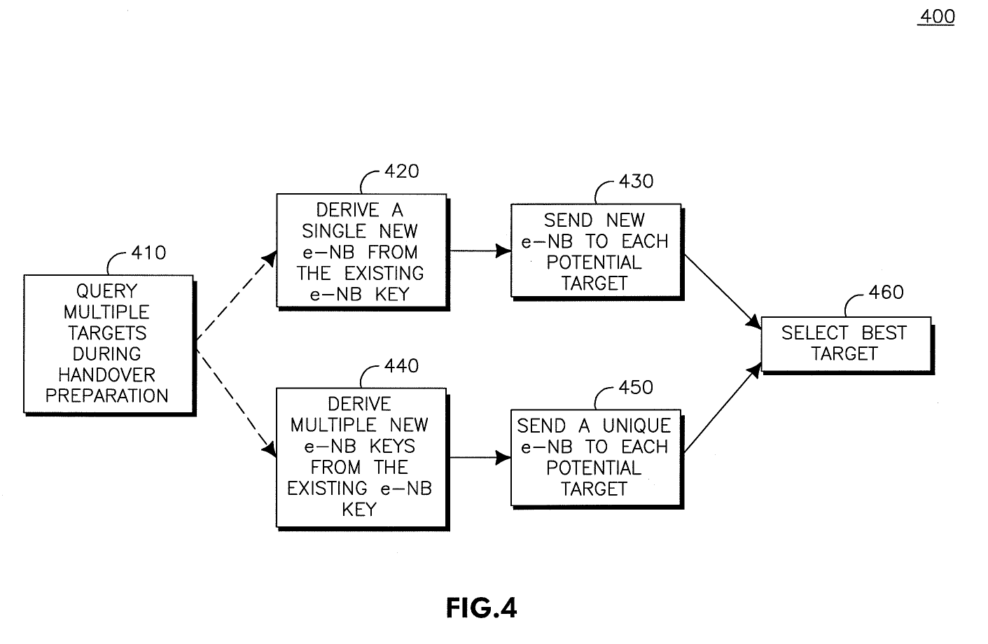

This check is performed by the source, assuming the source is not compromised, and ensures that the target is not attempting to “downgrade” security. FIG. 4 is a block diagram illustrating the actions taken when the source queries multiple targets during handover preparation 400, such as initial preparation or when looking for a new target. Specifically for LTE systems, the source may derive a single new e-NB key from the existing e-NB key 420 and then send it to each potential target 430 or it may derive multiple new e-NB keys from the existing e-NB key 440 and send a unique e-NB key to each potential target 450. To generate multiple unique e-NB keys from the existing e-NB key the source may generate a fresh random number and use it in the derivation of each new e-NB key. Based on the response from each target the source selects the best target 460, for example the target which supports the required algorithm set and the best radio/service related criteria. Note that this approach of querying multiple targets/cells/e-NBs may be used possibly only after a problem with the initial target is discovered.

For LTE systems the source may be the source e-NB or source MME and the target may be the target e-NB or the target MME. Therefore, in the above scenarios, it could be interpreted that the source e-NB queries the target e-NB, or the source e-NB queries the MME for information regarding the security algorithms the target uses.

Security Check by the WTRU During Handover

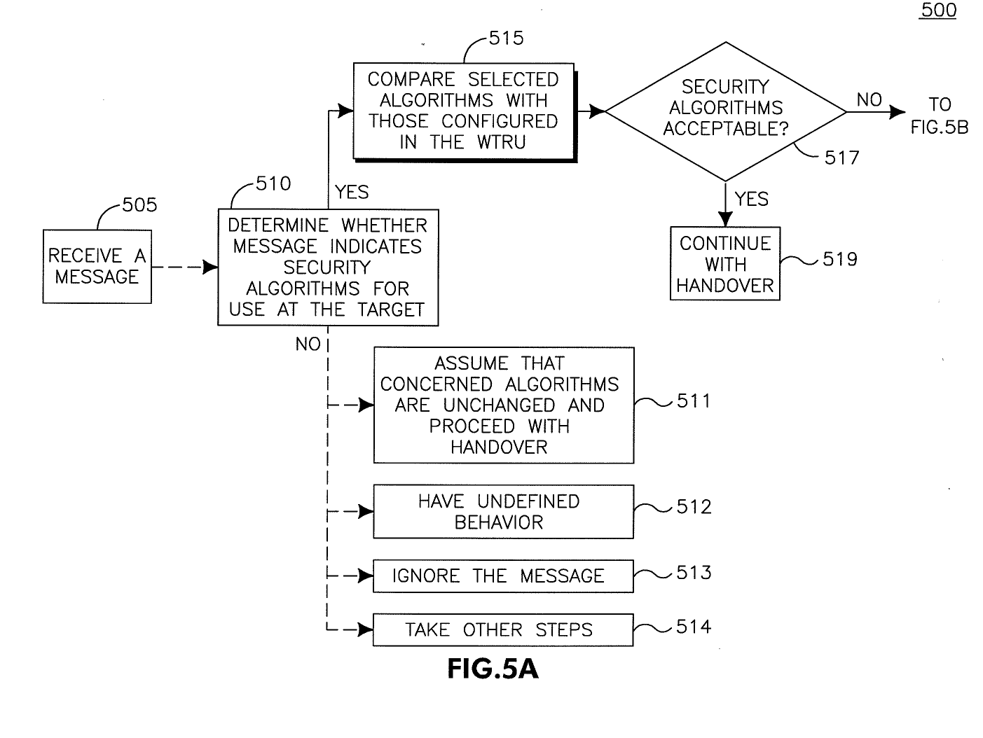

FIGS. 5A and 5B are block diagrams of a procedure 500 illustrating how a compromised source may “downgrade” security by modifying the algorithm selection made by the target before indicating it to the WTRU in the Handover Command. By ensuring that the WTRU checks the algorithm selection with its own capability and/or those algorithms configured to allow for use by the WTRU in its NAS Security Mode Command or equivalent message or configured by some other means, a check may be made as to whether the source attempted to downgrade security.

Specifically for LTE systems when, during handover, the WTRU receives a message, for example a HANDOVER COMMAND, from the source 505 it may do any of the following actions, in any order and in any combination:

It may check to see if the message indicates security algorithms to be used at the target (for RRC and/or U-PLANE) 510. If no indication of the security algorithms to be used at the target for RRC and/or U-plane, security in the form of ciphering and/or integrity protection may be provided, and the WTRU may assume that the concerned algorithms shall be unchanged and proceed with the handover 511, have undefined, i.e. implementation specific behavior 512, ignore the message 513, or take steps as defined below 514.

If an indication of the security algorithms to be used at the target for RRC and/or U-plane, security in the form of ciphering and/or integrity protection is provided, and the WTRU will compare the selected algorithms with those configured in the WTRU 515, for example during an earlier NAS Security Mode Command or any other previous NAS or RRC message, as being acceptable by the MME for that role.

If the security algorithms indicated are deemed as being acceptable 517 the WTRU shall continue with the handover 519. If the selected algorithms are deemed as being unacceptable, for example not in the included list configured by the MME, or the algorithms are absent, the WTRU may undertake any of the following actions in any combination and/or order. The specific procedure adopted may vary depending on the incompatible algorithm, i.e. RRC or U-plane ciphering and/or integrity protection. The procedures defined below may be used if any RRC or NAS message (e.g. an RRC SecurityModeCommand) tries to change any of the algorithms being used by the WTRU during the current AKA session i.e. only a new NAS Attach or AKA procedure may be used to change any of the NAS, RRC or U-plane ciphering and/or integrity protection algorithms.

The WTRU may set the variable INCOMPATIBLE_SECURITY_RECONFIGURATION or some other variable with a similar purpose to a value that indicates that the security reconfiguration is invalid 520. As an example, the INCOMPATIBLE_SECURITY_RECONFIGURATION variable (being a Boolean) could be set to TRUE. The WTRU may decide against handing over to target 525. The WTRU may indicate the decision to not hand over to the source, for example in a Handover failure message 530. The WTRU may include a cause IE in the message to source giving the reason for making this decision 535. The cause IE may indicate that the reason for not handing over was because of unacceptable security parameters. The WTRU may blacklist/bar/exclude/reduce priority/increase offset of the target e-NB/Cell and/or source e-NB/cell for future measurements/cell selection/cell re-selection/handover decisions 540, or send a NAS message to the MME 545. This message may include the identity of the target e-NB/cell and may include a cause IE that explains the reason for the message, for example incompatible security reconfiguration. The WTRU may ignore the message 550, transition to Idle mode 555, or send an updated measurement report to the source without including the target 560. This report may also include the target 565. If target is included, the target may be downgraded by an additional offset to reflect the earlier problems with incompatible security reconfiguration 570. This offset may be pre-determined or may be signaled to the WTRU. If the WTRU transitions to Idle mode 555 it may initiate procedures defined for handover failure or radio link failure recovery. The WTRU may continue with the handover process 575, or read the system information block (SIB) of the target cell before making the decision 580. The e-NB may broadcast the security algorithms it supports using SIBs, for example. The WTRU may read the SIBs to confirm if the target does not support the required security algorithms. This SIB information related to support for various algorithms may also be used as part of the initial cell selection process or cell re-selection process. The WTRU may notify the MME of the incompatible security configuration received 585, or delete any combination of the existing security keys 590, for example NAS, RRC, U-plane, K_{ASME} etc.

If several messages are received which attempt to indicate an invalid algorithm selection, the WTRU may take any of the steps indicated above in any combination or order. In addition, the WTRU may maintain a counter of the number of invalid messages 595.

Security Algorithm Mismatch During Handover

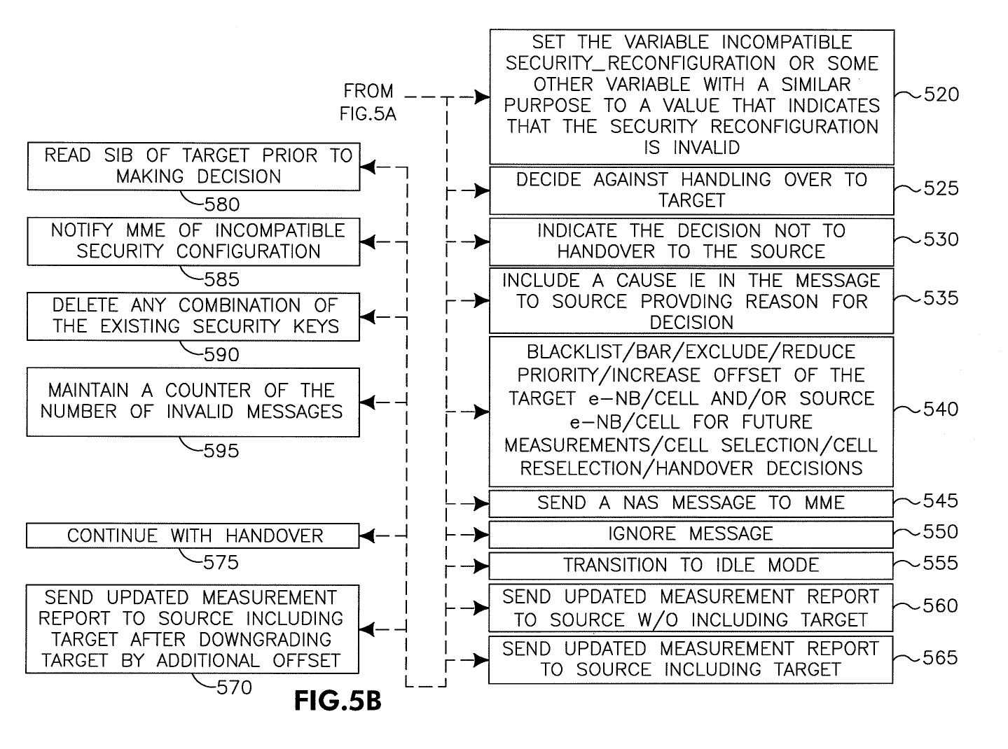

One other potential security problem that may arise is that a compromised source modifies the algorithm selection made by the target without necessarily downgrading it. FIG. 6 is a block diagram of an example in LTE systems 600 where the source e-NB selects a different algorithm(s) for RRC and/or U-plane ciphering and/or integrity protection than the one selected by the target e-NB 610. This selected algorithm is as commensurate with WTRU capabilities and is an acceptable algorithm as configured by the MME. The result is that the WTRU does not reject the handover, and when the WTRU hands over to the target, the security algorithms being used are incompatible because the target had indicated a different algorithm than the one indicated to the WTRU by the source 620. This may be considered to be a type of Denial of Service attack. It is also possible that this problem may occur for some other reason. In any case, the HANDOVER CONFIRM MESSAGE which is currently intended to be sent by the WTRU ciphered and integrity protected with the new RRC keys may be dropped by the target e-NB 630. The WTRU may also be unable to send or receive uplink or downlink data due to a similar problem with U-plane algorithm mismatch. This could be seen as a case of handover failure. In this case the handover procedure will fail and on the scenarios as mentioned in the next section on handover failure handling will result. If the handover is successful, the target e-NB may indicate to the MME the new K_{e-NB}.

Handover Failure

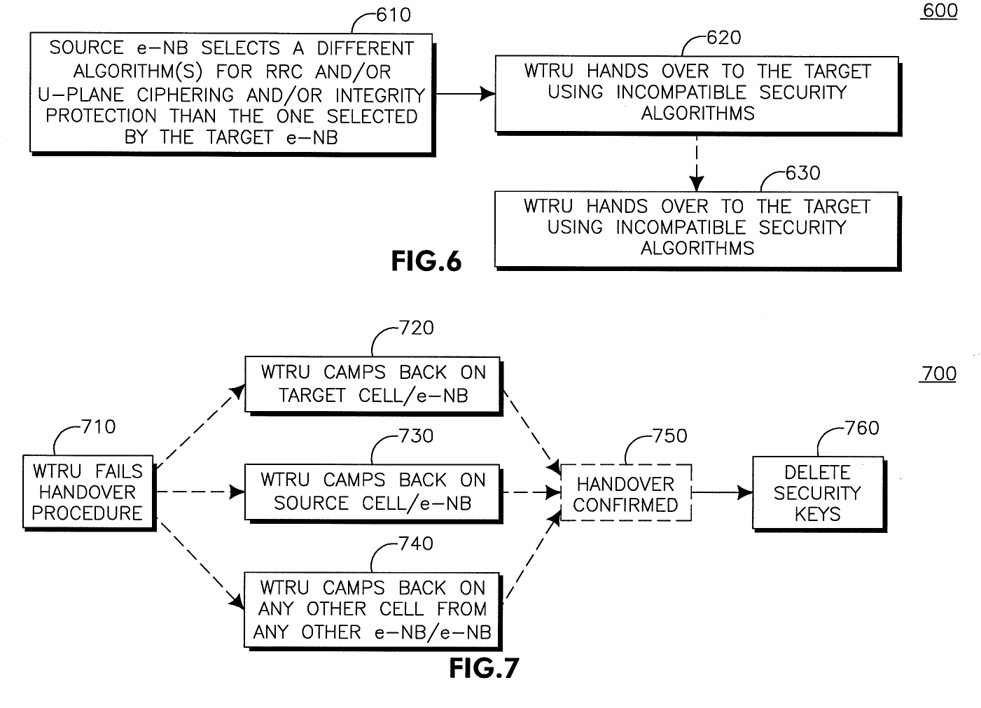

FIG. 7 is a block diagram of the effect on the WTRU when the handover procedure fails 700. As discussed above, when the WTRU receives the HO command it derives the new keys from the security algorithm given and C-RNTI/random number given. Once the WTRU fails the handover procedure 710 the WTRU can camp back on the Target cell/e-NB 720, camp back on the Source cell/e-NB 730, or camp on any other cell from any other e-NB 740.

The WTRU may choose to not delete its security keys, for example any combination of K_{ASME}, K_{eNB}, K_{RRCenc}, K_{RRCint}, K_{UPenc}, K_{NASenc}, K_{NASint}, until handover has been confirmed 750. This enables fast recovery in case of handover failure. Further the period of the time the e-NB can maintain these keys can be left to implementation, but the eNB would normally be expected to maintain its keys till timer T2 expires. Deletion of the security keys can be performed without confirming handover completion 760.

For WTRU camping back on the target cell/e-NB, WTRU could be allowed to use the security keys calculated during the handover procedure. Since the source cell/e-NB would have already passed the WTRU identity to the target cell/e-NB during the handover procedure, target cell/e-NB can use the same security keys as before and no new message is required.

If the WTRU camps back on the source cell/e-NB, WTRU could use the old security keys which it previously used on the source cell/e-NB.

The source/target eNB could signal to the WTRU using the Handover command if the WTRU should use the old/new security keys if it camps back after a handover failure or whether it should try and initiate a new security procedure. The source/target eNB could also indicate a time duration for which the security keys associated with the source/target eNB would be valid and if the WTRU camps back to the source/target cell/e-NB within this duration it could still use those keys. Alternatively one of the alternatives could be chosen and predefined in the standard. Alternatively the source/target e-NB could also signal to the WTRU a random number identified during the HO command which the WTRU can use to calculate its keys if it camps back on the source cell after a handover failure.

When the WTRU camps on a different cell/e-NB, the WTRU may discard the keys and reinitialize the entire security procedure. The WTRU may determine that the cell/e-NB is different by comparing the physical layer cell ID of the cell with that of the source or target cell or the identification of the cell or e-NB carried on the broadcast channel (e.g. SIB1).

When handover failure occurs, the WTRU may camp on source/target cell/e-NB and when it sends RRCConnectionReestablishmentRequest (or equivalent message) it may identify itself using a C-RNTI, KSI(s) or other equivalent ID that was allocated to it by the source/target. This message may also include information about whether WTRU has valid security parameters, for example an IE could indicate the KSI for a previously derived Key Set. The source/target may check its records to identify any existing security association for the given WTRU. If a record exists the source/target may choose not to re-initialize security and signal this to the WTRU, for example in a RRCConnectionReestablishment or equivalent message.

Change in PLMN

The key hierarchy proposed for LTE shows that the master key (K_{ASME}) depends on the PLMN of the serving network. However, since it is possible that a change in PLMN may occur in Idle Mode or in Active Mode, the WTRU procedures related to security should be defined for when that happens.

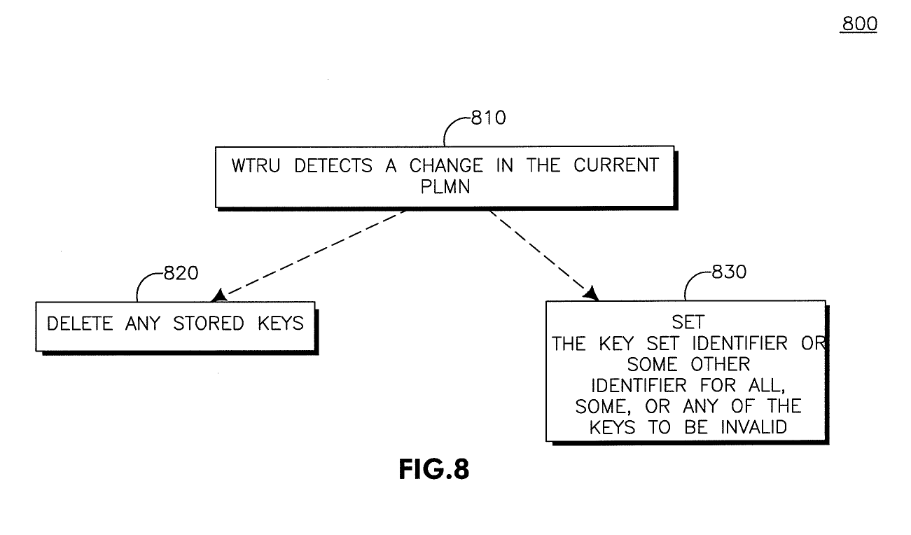

FIG. 8 is a block diagram of a procedure related to security when a change in PLMN occurs in Idle Mode or Active Mode. As shown in FIG. 8, if a WTRU detects a change in the current PLMN 810, for example as part of PLMN selection procedures/background PLMN search, the WTRU may delete any stored security keys 820. This may include all of or any combination of the CK, IK, K_{ASME}, NAS, RRC and U-plane keys. The WTRU may also set the Key Set Identifier (KSI) or some other identifier for all or some or any of the keys, for example K_{ASME}, K_{CK}, K_{IK}, NAS keys, U-plane keys, and RRC keys, to be invalid 830, for example by setting them to the number ‘111’. This ensures that the new PLMN will receive an ATTACH REQUEST or equivalent message from the WTRU with invalid security configuration and initiate a new AKA procedure. The WTRU may perform some other procedure which achieves the same purpose, i.e. prompts a new AKA run during next ACTIVE mode transfer.

Further, a WTRU in possession of valid root keys, for example CK, IK, K_{ASME}, and NAS security keys, may choose not to delete these keys if it enters LTE_Idle, LTE_Detached, or an equivalent state, i.e. when no Signaling connection exists to the MME. The WTRU may choose to delete these keys only when a new PLMN is selected, if any associated timer times out, or upon some other event, for example generation of equivalent new keys upon transition to LTE_Active or as a result of a new AKA run.

Simplified NAS Security Architecture

The following describes architecture for NAS ciphering and integrity protection. The architecture discussed below can be defined per NAS PDU/SAP. NAS signaling may be ciphered and/or integrity protected using one or more of the following schemes in any order and/or combination. The NAS signaling may be ciphered and/or integrity protected per SAP, for example per GMMAS-SAP, per Transaction Identity, per NAS PDU, per Message Type, for example Common procedures/Specific Procedures, per Protocol Type, for example MM/SM, and per underlying EPS bearers/signaling radio bearers, i.e. NAS messages being mapped to different underlying bearers may be ciphered differently.

In UMTS, some SRBs are for high priority NAS signaling and others for low priority. Extending scheme to LTE is possible by ciphering high priority NAS messages differently than low priority NAS messages.

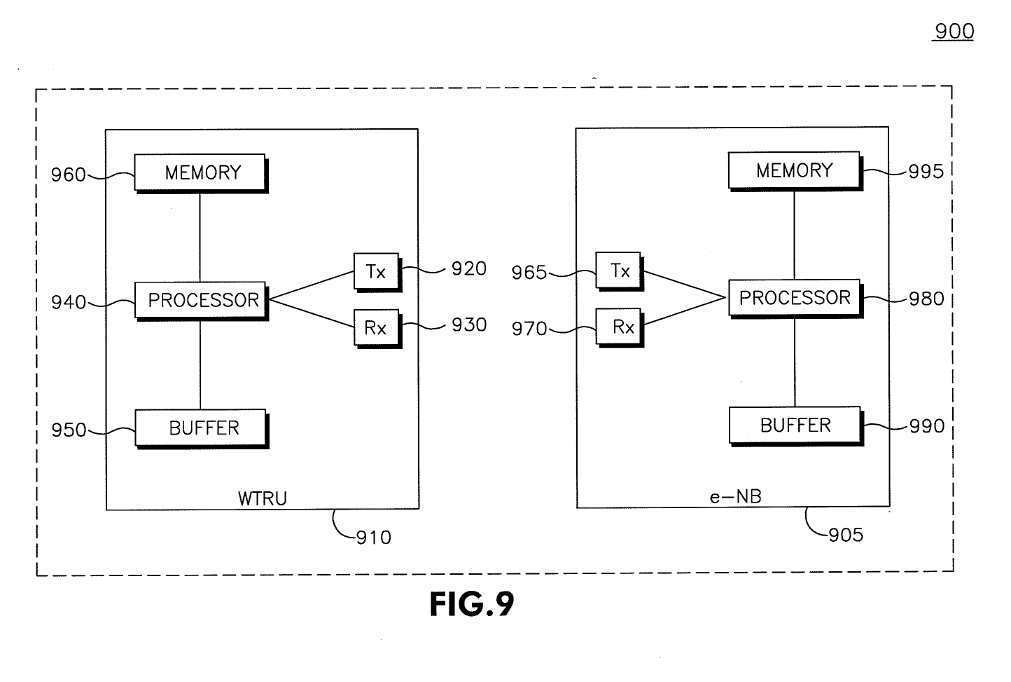

FIG. 9 is a block diagram of a wireless communication system 900 configured for secured handover in LTE. The system includes an enhanced Node-B (e-NB) 905 and a wireless transmit receive unit (WTRU) 910. The base station 905 and the WTRU 910 communicate via a wireless communications link.

As shown in FIG. 9, the WTRU 910 includes a transmitter 920, a receiver 930, and a processor 940. The processor 940 is attached to a buffer 950 and a memory 960. The processor 940 is configured to determine whether the handover command indicates security algorithms for use at the target using at least one technique described above.

Also shown in FIG. 9, is the e-NB 905 which includes a transmitter 965, a receiver 970, and a processor 980. The processor 980 is attached to a buffer 990 and a memory 995. The processor 980 is configured to determine whether the handover command indicates security algorithms for use at the target using at least one technique described above.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for performing a security check in wireless communications, the method comprising:
receiving a message;
determining whether the message is attempting to change one or more security algorithms in use; and
performing a security action based on the determination.

2. The method of claim 1 wherein the message is a handover command.

3. The method of claim 1 further comprising:
determining whether the handover command indicates security algorithms for use at a target.

4. The method as in claim 1, wherein a wireless transmit/receive unit (WTRU) is performing at least one of a plurality of security actions in determining that a handover command does not indicate security algorithms for use at a target, the plurality of security actions include proceeding with handover if the security algorithms are unchanged, having an implementation specific behavior if the security algorithms are changed, ignoring the command if the security algorithms are changed, and taking predetermined steps if the security algorithms are changed.

5. The method of claim 4, wherein taking predetermined steps includes at least one of the following: setting the variable INCOMATIBLE_SECURITY_RECONFIGURATION to a value that indicates that a security reconfiguration is invalid; deciding against handover; indicating a decision not to handover; including a Cause information element (IE) in a message providing a reason for the decision; ignoring a message which indicates a change in algorithm; ignoring the message which indicates a change in algorithm unless received in the context of a new AKA or ATTACH procedure; increasing an offset; sending a NAS message; ignoring the handover command; transitioning to Idle Mode; performing actions defined for handover failure or radio link failure; sending an updated measurement report; continuing with the handover; reading a system information block (SIB) prior to making a decision; sending a notification of incompatible security configuration; deleting any combination of existing security keys; and maintaining a counter of the number of invalid handover commands.

6. The method as in claim 1, further comprising:
selecting algorithms for use at a target.

7. The method as in claim 6, further comprising:
determining whether the selected algorithms are acceptable.

8. The method as in claim 7, wherein a wireless transmit/receive (WTRU) compares the selected algorithms with the acceptable algorithms.

9. The method as in claim 7, wherein a wireless transmit/receive unit (WTRU) continues with the handover if the selected algorithms are acceptable.

10. The method as in claim 7, wherein a wireless transmit/receive unit (WTRU) performs at least one of a plurality of security actions if the selected algorithms are not acceptable, the plurality of security actions include setting variable INCOMATIBLE_SECURITY_RECONFIGURATION to a value that indicates that a security reconfiguration is invalid; deciding against handover; indicating a decision not to handover; including a Cause information element (IE) in a message providing a reason for the decision; ignoring a message which indicates a change in algorithm; ignoring a message which indicates a change in algorithm unless received in the context of a new AKA or ATTACH procedure; increasing an offset; sending a NAS message; ignoring the handover command; transitioning to Idle Mode; performing actions defined for handover failure or radio link failure; sending an updated measurement report; continuing with the handover; reading a system information block (SIB) prior to making a decision; sending a notification of incompatible security configuration; deleting any combination of existing security keys; and maintaining a counter of the number of invalid handover commands.

11. A method for performing a security action in wireless communications during a change in public land mobile network (PLMN), the method comprising:
detecting a change in a current PLMN; and
performing a security action.

12. The method of claim 11, wherein the security action is deleting any stored security keys and an algorithm identifier.

13. The method of claim 12, wherein the stored keys include at least one of K_{ASME}, CK, IK, K_{NASenc}, K_{NASint}, K_{e-NB}, K_{RRCenc}, K_{RRCint}, and K_{UPenc}.

14. The method of claim 12, wherein the algorithm identifier is at least one of an identifier for the algorithm used in ciphering of non-access stratum (NAS) signaling, integrity protection of NAS signaling, ciphering of radio resource controller (RRC) signaling, integrity protection of RRC signaling and ciphering of user-plane traffic.

15. The method of claim 11, wherein the security action is setting a key identifier to be invalid.

16. The method of claim 15, wherein the key identifier is a Key Set Identifier (KSI).

17. The method of claim 11, wherein the security action is prompting an authentication and key agreement (AKA) run during a subsequent ACTIVE mode transfer.

18. The method of claim 11, wherein the security action is choosing not to delete valid root keys of a wireless transmit/receive unit (WTRU) when one of the following states is entered: LTE_Idle and LTE_Detached.

19. The method of claim 11, wherein the security action is choosing not to delete valid root keys of a wireless transmit/receive unit (WTRU) when no signaling connection exists to a multimedia message entity (MME).

20. The method of claim 11, wherein the security action is choosing to delete keys when a new PLMN is selected.

21. The method of claim 11, wherein the security action is choosing to delete keys when an associated timer times out.

22. The method of claim 11, wherein the security action is generating keys upon transition to LTE_Active mode.

23. The method of claim 11, wherein the security action is generating keys upon the initiation of an authentication and key agreement (AKA) run.

24. A wireless transmit/receive unit (WTRU) comprising:
a receiver configured to receive a message; and
a processor configured to determine whether the message indicates security algorithms for use at a target.

25. The WTRU of claim 24, wherein the processor is configured to perform at least one of a plurality of security actions in determining that a handover command does not indicate security algorithms for use at the target; the plurality of security actions include proceeding with handover if the security algorithms are unchanged, having an implementation specific behavior if the security algorithms are changed, ignoring the command if the security algorithms are changed, and taking predetermined steps if the security algorithms are changed.

26. The WTRU of claim 25, wherein taking predetermined steps includes at least one of the following: setting the variable INCOMATIBLE_SECURITY_RECONFIGURATION to a value that indicates that a security reconfiguration is invalid; deciding against handover; indicating a decision not to handover; including a Cause information element (IE) in a message providing a reason for the decision; ignoring a message which indicates a change in algorithm; ignoring a message which indicates a change in algorithm unless received in the context of a new AKA or ATTACH procedure; increasing an offset; sending a NAS message; ignoring the handover command; transitioning to Idle Mode; performing actions defined for handover failure or radio link failure; sending an updated measurement report; continuing with the handover; reading a system information block (SIB) prior to making a decision; sending a notification of incompatible security configuration; deleting any combination of existing security keys; and maintaining a counter of the number of invalid handover commands.

27. The WTRU of claim 24, further comprising:
a selector configured to select algorithms for use at the target.

28. The WTRU of claim 24, wherein the processor is further configured to determine whether selected algorithms are acceptable.

29. The WTRU of claim 28, wherein the processor is configured to compare the selected algorithms with the acceptable algorithms.

30. The WTRU of claim 28, wherein the processor is configured to continue with the handover if selected algorithms are acceptable.

31. The WTRU of claim 24, wherein the processor is configured to perform at least one of a plurality of security actions if selected algorithms are not acceptable, the plurality of security actions include setting the variable INCOMATIBLE_SECURITY_RECONFIGURATION to a value that indicates that a security reconfiguration is invalid; deciding against handover; indicating the decision not to handover; including a Cause information element (IE) in a message providing a reason for the decision; ignoring a message which indicates a change in algorithm; ignoring the message which indicates a change in algorithm unless received in the context of a new AKA or ATTACH procedure; increasing an offset; sending a NAS message; ignoring the handover command; transitioning to Idle Mode; performing actions defined for handover failure or radio link failure; sending an updated measurement report; continuing with the handover; reading a system information block (SIB) prior to making a decision; sending a notification of incompatible security configuration; deleting any combination of existing security keys; and maintaining a counter of the number of invalid handover commands.

32. The WTRU of claim 24 further comprising:
a detector configured to detect a change in a current public land mobile network (PLMN); and wherein the processor is further configured to perform a security action.

33. An evolved Node-B (e-NB) comprising:
a receiver configured to receive a message; and
a processor configured to determine whether the message indicates security algorithms for use at a target.
